(19) United States
(12) Patent Application Publication
(10) Pub. No.: US 2020/0053645 A1
(43) Pub. Date: Feb. 13, 2020

(54) User Equipment Group Wake-Up Signal In NB-IoT

(71) Applicant: MediaTek Inc., Hsinchu City (TW)

(72) Inventors: Gilles Charbit, Hampshire (GB); Shiang-Jiun Lin, Hsinchu City (TW); Li-Chuan Tseng, Hsinchu City (TW); Per Johan Mikael Johansson, Kungsangen (SE)

(21) Appl. No.: 16/535,050

(22) Filed: Aug. 7, 2019

Related U.S. Application Data
(60) Provisional application No. 62/717,159, filed on Aug. 10, 2018.

(51) Int. Cl. H04W 52/02; H04W 68/00; H04W 76/11; H04W 68/10; H04W 76/27; H04W 76/28

(52) U.S. Cl. CPC H04W 52/0229; H04W 68/005; H04W 76/28; H04W 68/10; H04W 76/27; H04W 76/11

(57) ABSTRACT

Various examples and schemes pertaining to user equipment (UE) group wake-up signal (WUS) in narrowband IoT (NB-IoT) are described. A wireless network indicates to a plurality of user equipment (UEs) a paging configuration of a UE-group wake-up signal (WUS) for one or more groups of UEs among the plurality of UEs in an NB-IoT cell. The paging configuration may be related to a discontinuous reception (DRX) cycle and a value related to UE identification of each UE in the one or more groups of UEs. The wireless network also transmits the UE-group WUS to the one or more groups of UEs.

### CROSS REFERENCE TO RELATED PATENT APPLICATION(S)

The present disclosure is part of a non-provisional application claiming the priority benefit of U.S. Patent Application No. 62/717,159, filed on 10 Aug. 2018, the content of which being incorporated by reference in its entirety.

### TECHNICAL FIELD

The present disclosure is generally related to Internet of Things (IoT) and, more particularly, to user equipment (UE) group wake-up signal (WUS) in narrowband IoT (NB-IoT).

### BACKGROUND

Unless otherwise indicated herein, approaches described in this section are not prior art to the claims listed below and are not admitted as prior art by inclusion in this section.

NB-IoT is a low-power wide-area networking radio technology standard developed by the 3rd-Generation Partnership Project (3GPP) to enable a wide range of cellular devices, or UEs, and services. A new radio access network (RAN)-level working item on release 16 (Rel-16) of the 3GPP specification for NB-IoT was approved to aim to study enhancement on UE-group WUS to achieve improved downlink (DL) transmission efficiency and/or reduced UE power consumption.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure aims to provide schemes, solutions, concepts, designs, methods and systems pertaining to UE-group WUS for NB-IoT to achieve improved DL transmission efficiency and/or reduced UE power consumption.

In one aspect, a method may involve a processor of a network node of a wireless network indicating to a plurality of user equipment (UEs) a paging configuration of a UE-group wake-up signal (WUS) for one or more groups of UEs among the plurality of UEs in an NB-IoT cell. The paging configuration may be related to a discontinuous reception (DRX) cycle and a value related to UE identification (UE_ID) of each UE in the one or more groups of UEs. The method may also involve the processor transmitting the UE-group WUS to the one or more groups of UEs.

In one aspect, a method may involve a processor of a UE receiving from a wireless network a paging configuration of a UE-group WUS for one or more groups of UEs, to which the UE belongs, among the plurality of UEs in an NB-IoT cell. The paging configuration may be related to a DRX cycle and a value related to UE identification (UE_ID) of each UE in the one or more groups of UEs. The method may also involve the processor receiving from the wireless network the UE-group WUS.

It is noteworthy that, although description provided herein may be in the context of certain radio access technologies, networks and network topologies such as IoT and NB-IoT, the proposed concepts, schemes and any variation(s)/derivative(s) thereof may be implemented in, for and by other types of radio access technologies, networks and network topologies such as, for example and without limitation, 5th Generation (5G), New Radio (NR), Long-Term Evolution (LTE), LTE-Advanced, LTE-Advanced Pro. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with the present disclosure.

FIG. 3 is a diagram of an example scenario in accordance with the present disclosure.

FIG. 4 is a diagram of an example scenario in accordance with the present disclosure.

FIG. 5 is a diagram of an example scenario in accordance with the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UE-group WUS in NB-IoT. According to the present disclosure, a number of possible solutions may be implemented separately or jointly. That is, although these possible solutions may be described below separately, two or more of these possible solutions may be implemented in one combination or another.

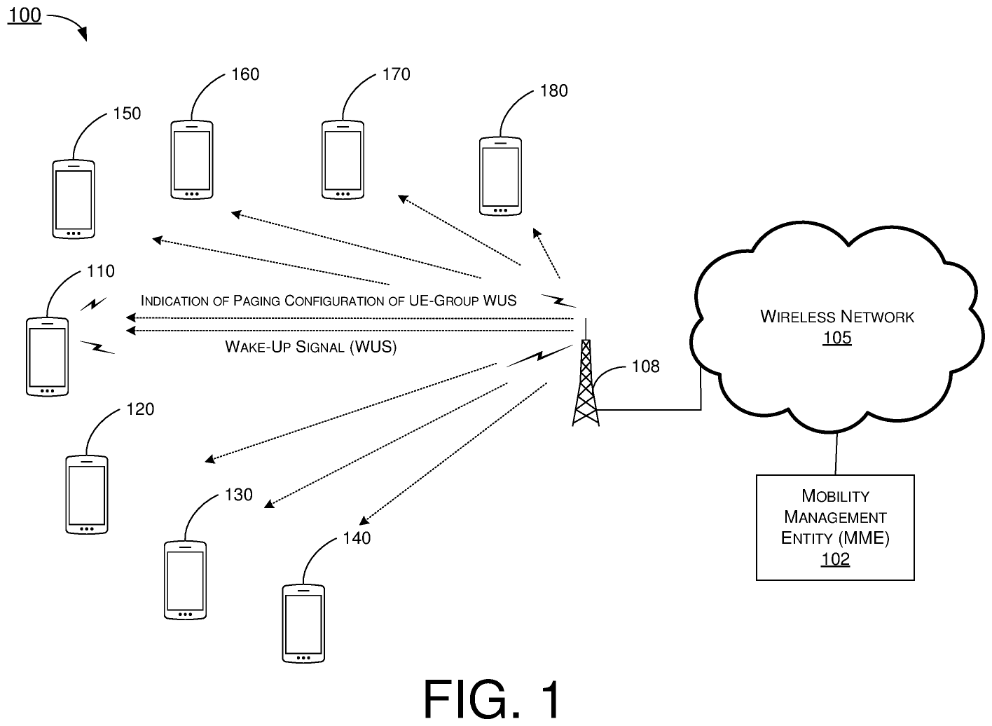

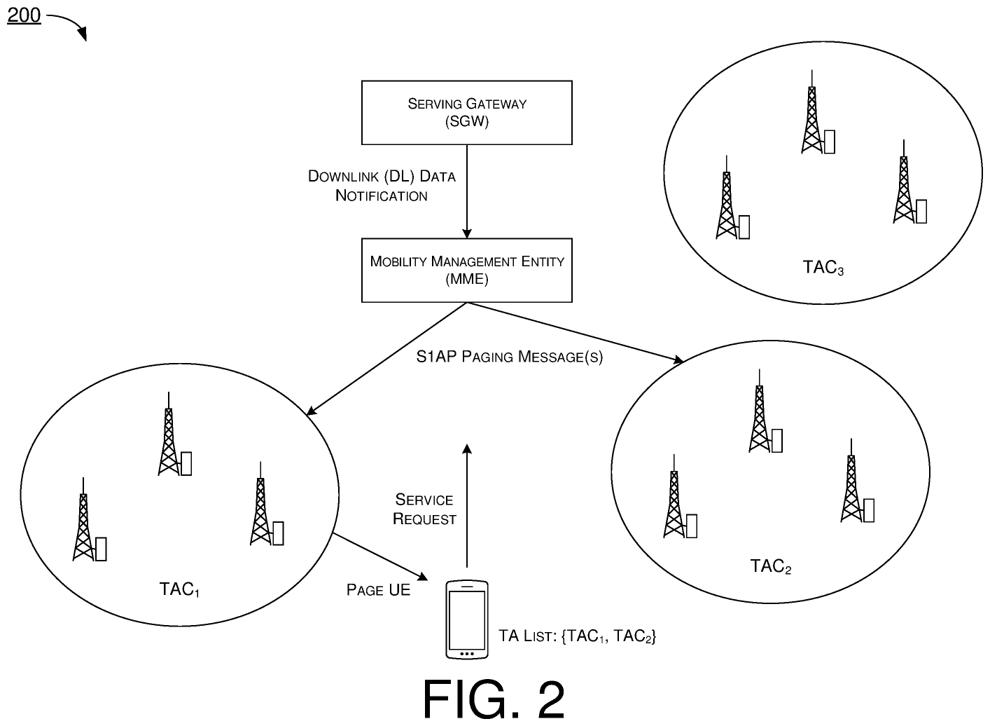

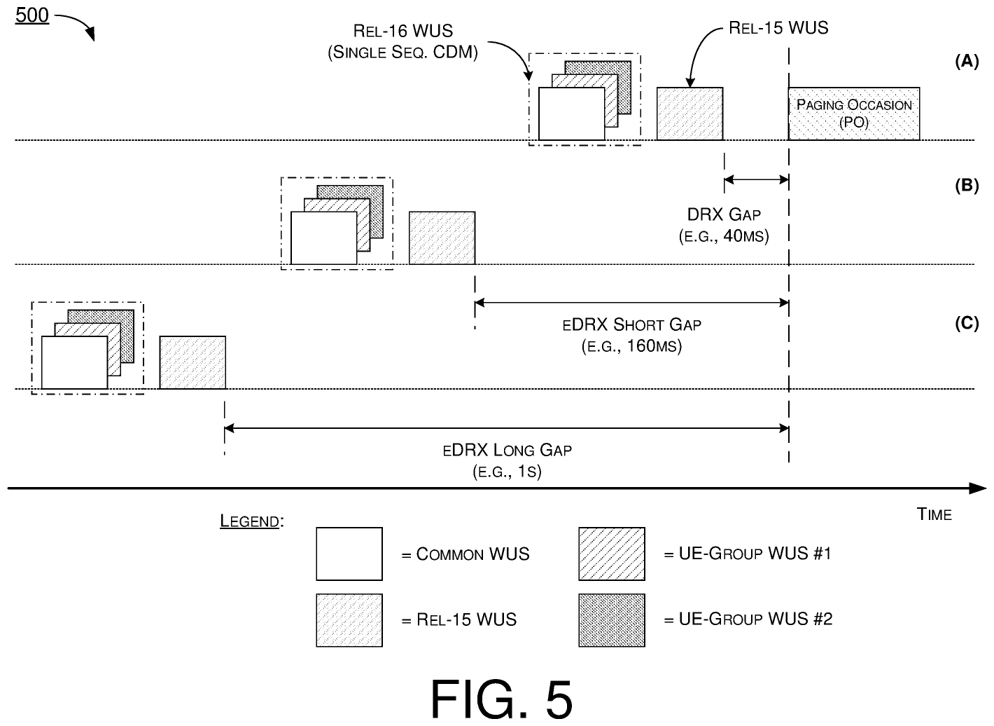

FIG. 1 illustrates an example network environment 100 in which various solutions and schemes in accordance with the present disclosure may be implemented. Each of FIG. 2˜FIG. 5 illustrates an example scenario 200, 300, 400 or 500, respectively, in accordance with the present disclosure. Scenario 200 shows an example of Mobility Management Entity (MME)-level UE grouping for paging. Scenario 300 shows an example of radio access network (RAN)-level UE grouping for paging. Scenario 400 shows an example of paging occasion (PO) configuration with 16 repetitions for narrowband physical downlink control channel (NPDCCH). Scenario 500 shows an example of UE-group WUS. Each of scenarios 200, 300, 400 and 500 may be implemented in network environment 100. The following description of various proposed schemes is provided with reference to FIG. 1-FIG. 5.

Referring to FIG. 1, network environment 100 may involve a plurality of UEs 110˜180 in wireless communication with a wireless network 105 (e.g., an NB-IoT network), including a Mobility Management Entity (MME) 102 of wireless network 105, via a base station 108 (e.g., an eNB, gNB or transmit-receive point (TRP)). In network environment 100, one or more of UEs 110˜180 and wireless network 105 may implement various schemes pertaining to UE-group WUS in NB-IoT in accordance with the present disclosure. For instance, UE 110 may receive, and network 105 may transmit, an NRS in accordance with various schemes proposed herein.

In general, there may be several tends of thousands of UEs with the same vale (UE_ID) related to a UE identification of each of the UEs sharing the same configuration for paging frame (PF) and/or paging opportunity (PO) in the same network, depending on paging parameters such as, for example, narrow-bandwidth (nB) broadcast on system information block 2 (SIB2) and paging cycle length. Thus, in practicality only a smaller number of UEs can be paged at any given time in a PF/PO due to finite physical resources for NPDCCH (e.g., two network control elements (NCCEs) per resource block (RB) in closed subscriber group (CSG) subscriber server (CSS) Type 1) and narrowband physical downlink shared channel (NPDSCH). Accordingly, several RBs would be needed for NPDCCH and NPDSCH to transmit paging messages depending on the level of repetitions.

Grouping of UEs may be utilized in real-life networks to page a small number (or small group) of UEs per PF and/or PO in one of two approaches. The first approach, a mobility management entity (MME)-level approach, may involve tracking area (TA) across several base stations (e.g., eNB and/or gNB) as indicated in a tracking area list (TAL) and/or tracking area code (TAC). The second approach, a RAN-level approach, may involve scheduling paging of messages by a base station.

Under the MME-level approach of UE grouping for paging, as shown in FIG. 2, MME 102 may provide each of UEs 110˜180 with a list of tracking areas (TAs), or TAL, where UE registration for UE 110 is valid. When MME 102 pages a UE (e.g., UE 110) one of UE 110, a paging message may be sent to all base stations (including base station 108) in the TAL. TA updates may occur periodically. When UE 110 enters a cell with a TAC not in the current TAL, MME 102 (or RAN) may first attempt to send paging in the last base station where paging to UE 110 was successfully received and then try other base stations with TACs in the TAL. On the other hand, UE 110 may attempt to detect paging in one or more associated PO(s).

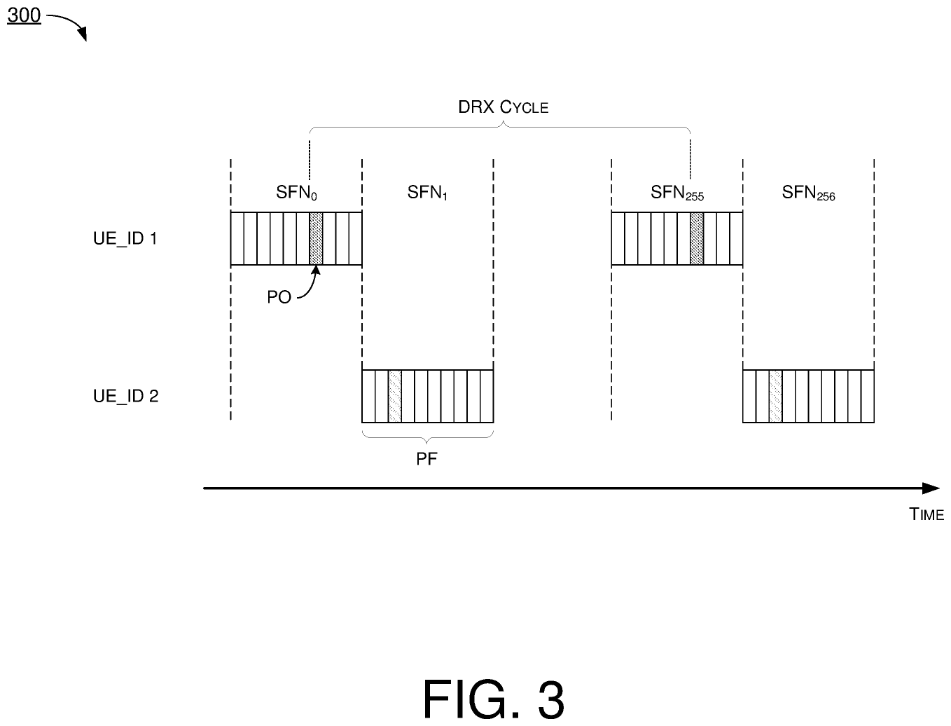

Under the RAN-level approach of UE grouping of paging, as shown in FIG. 3, each of UEs 110˜180 may be identified by its respective UE_ID at RAN level. The UE_ID may be related to, derived from, linked to or otherwise associated with the International Mobile Subscriber Identity (IMSI) of the UE. For example, when UE_ID=IMSI mod 4096, the PF may be related to, derived from, linked to or otherwise associated with a System Frame Number (SFN) and UE_ID as follows:

PF=SFN mod T=(T div N)*(UE_ID mod N).

The parameter T denotes a discontinuous reception (DRX) cycle, typically set to DefaultPagingCycle=128, 256, 512 or 1024 radio frames (10 ms). The parameter N may be expressed as N=min (T, nB), nB: 4T, 2T, T, T/2, T/4, T/8, T/16, T/32, T/64, T/128, T/256, T/512, T/1024.

One paging frame (PF), as one radio frame, may contain one or more paging opportunities (POs). When DRX is used, a UE may need to monitor one PO per DRX cycle and not more. The number of POs in a PF may be determined by Ns: max (1, nB/T). Moreover, an index (i_s) pointing to PO from a subframe may be defined as i_s=floor (UE_ID/N) mode Ns.

In an event that paging configuration for a non-anchor carrier is provided in system information, the paging carrier may be determined as the smallest index n (0≤n≤Nn−1) fulfilling the following expression:

floor(UE_ID/(N*Ns))mod W<W(0)+W(1)++W(n).

The parameter Nn denotes the number of paging narrowband carriers (for paging radio network temporary identifier (P-RNTI) monitored on machine-type communication (MTC) physical downlink control channel (MPDCCH)) or paging carriers (for P-RNTI monitored on NPDCCH) provided in system information. The parameter W(i) denotes the weight for NB-IoT paging carrier i. The parameter W denotes the total weight of all NB-IoT paging carriers such that W=W(0)+W(1)+ . . . +W(Nn−1).

The minimum number of UE groups for paging in a DRX cycle may be 1, corresponding to one paging carrier, one PF in a paging cycle and one PO in a PF. The maximum number of UE groups for paging may be N*Ns*Nn, corresponding to Nn paging carriers, N PFs in a paging cycle and Ns POs in a PF.

The UE (e.g., any of UEs 110˜180) may need to receive NPDCCH in Common Search Space Type 1 and associated NPDSCH for paging with many repetitions depending on Coverage Enhancement (CE) mode. Further, NPDCCH cannot be transmitted in DL invalid subframes. Thus, an interval between two POs would need to be large enough to accommodate physical downlink control channel (PDCCH) and physical downlink shared channel (PDSCH) with repetitions. In an event that there is a WUS associated with a PO, the interval between two POs would need to accommodate a WUS repetition level as well.

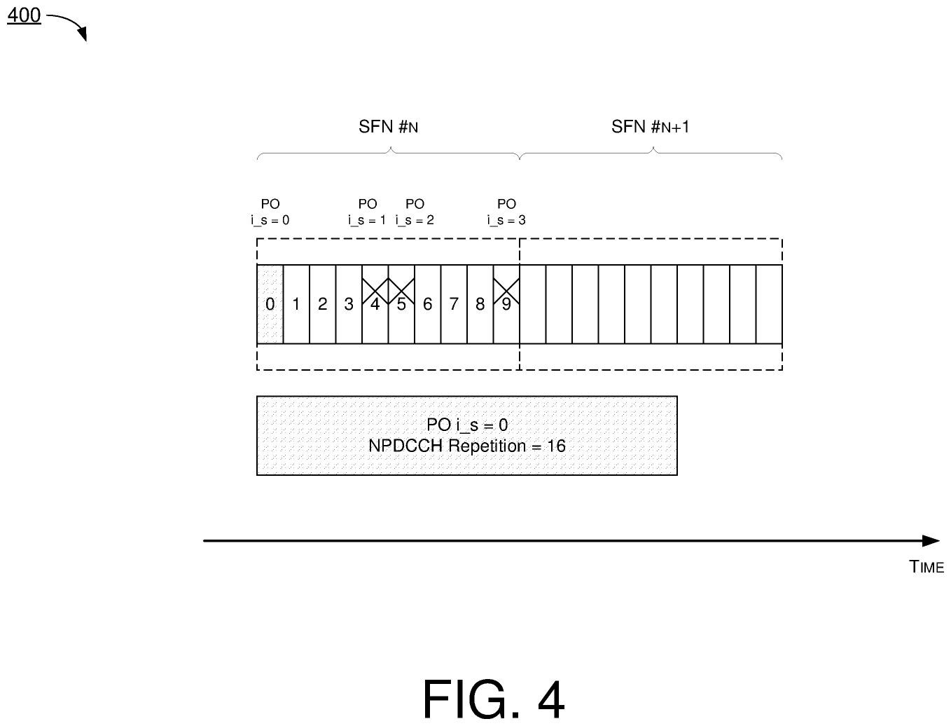

Referring to FIG. 4, scenario 400 shows an example PO configuration in which, although there are four PO candidates in a PF (e.g., the POs numbered “0”, “4”, “5” and “9” in FIG. 4 with i_s=0, i_s=1, i_s=2 and i_s=3, respectively), only one PO (e.g., the PO numbered “0”) can be configured by the network due to repetitions of NPDCCH. Thus, there are 16 repetitions of the paging configuration (for 16 POs) for NPDCCH in scenario 400.

As an illustrative and non-limiting example, one paging configuration in the field may include the following parameters:

| | | |
|---|---|---|
| pcchConfig.defaultPagingCycle | = 0x0100 | 256; |
| body.nphyldelConfigReg.pcchConfig.nb | = NPHY_NB_1_DIV8 | 0x05; |
| body.nphyldleConfigReg.pcchConfig.- | = 0x07a6 | 1958; |
| ueId | | |
| pcchConfig.npdcchNumRepetition- | = 0x0010 | 16. |
| Paging | | |

That is:

Paging cycle T=256;

nB=T/8=256/8=32;

N=min (T, nB)=32; and

Ns=max (1, nB/T)=1.

By this configuration, a paging cycle is 2560 ms, and there are 32 PFs in the paging cycle and 1 PO in a PF. The interval between two POs is 80 ms. In an event that one paging carrier is configured in the network, the total number of POs in a paging cycle is 32. Assuming that there are 100,000 UEs in the TA with uniformly random UE_ID, then on average there may be 3,125 UEs associated to a PO. Once a UE in the PO has been paged, all other UEs in the same PO need to decode the paging message.

In an event that the UEs in the same PO can be further sub-divided into different UE groups that are associated to different WUS signals, the probability of unnecessarily waking up a UE may be reduced. For instance, with five WUS signals associated to a PO, on average 625 UEs would be associated to the same WUS with a fivefold reduction in unnecessary wake probability. It is noteworthy that the UE wake-up probability may be expressed as follows:

P(x,n)=x+[(1−x)*(1−(1−x)\hat{ }(n−1))].

The parameter x denotes the paging rate of a UE and the parameter n denotes the number of UEs associated to a WUS.

Thus, the maximum number of POs and the corresponding UE groups for paging may need to allow repetitions for WUS and associated NPDCCH and NPDSCH. The correlation between WUS and associated NPDCCH may also need to be considered. Additionally, there may be a minimum of one UE group and a maximum of N*Ns*Nn UE groups among the UEs sharing the same UE_ID, where N=min (T, nB), Ns: max (1, nB/T), and Nn is the number of paging carriers.

Thus, it would be desirable that the UE-groups WUS re-used the same UE-group paging as the baseline. This may be achieved in a straightforward way with UE-group WUS re-using paging configuration for UE-group paging without any change to the legacy paging procedure. For instance, paging configuration with UE groups related to, linked to or otherwise associated with UE_ID=IMSI mod 4096 and radio resource control (RRC) DRX configuration may be the baseline for UE-group WUS.

It is noteworthy that the baseline described above allows more manageable number of UEs that require WUS with grouping at MME level and RAN level. However, as addressed above, the interval between POs need to be large enough to accommodate the possible repetition of NPDCCH, NPDSCH for paging and the WUS so that the PO might be configured in a sparse way. Accordingly, it may be desirable to have finer granularity for grouping UEs for WUS. A UE that is in a UE-group for paging may need to wake up in an event that another UE in the same group is paged following detection of an associated WUS. Moreover, in case that a UE in a paging group detects a WUS because other UEs in the same paging group are paged, the UE would need to wake up and detect NPDCCH and/or NPDSCH to receive paging message(s). In a worst-case scenario, when there may be excessive paging load, a UE may need to wake up most of the time. Thus, it can be seen that a finer granularity for WUS UE grouping compared to paging grouping may allow further reduction in power consumption for UEs.

Under a proposed scheme in accordance with the present disclosure, there may be several UE-group WUS approaches supported via RRC configuration without any change to the physical layer. A first approach may involve UE-group WUS within a PO. A second approach may involve dropping paging message(s) in a PF or PO.

Under the first approach, UE-group WUS may be further accomplished within a PO. For example, as a similar mechanism to PF, PO determination may be applied to determination of WUS grouping. Assuming that there are Nw WUS signals allocated in a PO, the UEs associated to the PO may be further divided into Nw WUS groups each associated to a respective WUS by the following expression:

i_w=floor(UE_ID/(N*Ns))mod Nw.

Thus, only the UEs in a PO that are associated to the same WUS signal would need to wake up whenever any of the UEs in that same WUS group has been paged. Under the proposed scheme, the number of WUS groups in a PO may be signaled by RRC configuration.

The multiple UE-group WUS signals associated to different groups of UEs in a PO may be transmitted in the same time and/or frequency response in a code-division multiplexing (CDM) manner in an event that the code domain resource is large enough. Otherwise, some cover codes may be added on top of the original WUS associated to a PO. Alternatively, the UE-group WUS signals associated to different groups of UEs in a PO may be transmitted in a time-division multiplexing (TDM) manner or frequency-division multiplexing (FDM) manner. The network may inform a given UE where to detect its associated WUS. Accordingly, UE-group WUS may be supported within a PO via RRC configuration, thereby reducing power consumption for UEs.

Under the second approach, higher UE grouping granularity within a PO may reduce power consumption for UEs. To further reduce power consumption, a base station may postpone paging or drop paging in a given configured PF and/or PO in an event that there is no associated WUS configured before the PF/PO. Additionally, the base station may prioritize paging to UE(s) for PF/PO when associated WUS resource is configured. Furthermore, the base station may configure WUS periodicity to be a multiple of the DRX cycle. This approach may have more flexibility than increasing the DRX cycle for paging and transmitting WUS before each PF. Moreover, the base station may configure different periodicities for the WUS configuration of UEs. It may be up to the base station's scheduler to ensure that paging is only scheduled in a cell when WUS is also scheduled for a given UE. In a worst-case scenario, the base station may postpone scheduling of paging until the corresponding WUS is scheduled, as it may be reasonable to miss some paging messages given that this may not be likely to happen. It is noteworthy that this approach may be extended to extended DRX (eDRX) where, unless paged, UE(s) monitor one or more POs within a paging transmission window (PTW).

Referring to FIG. 5, scenario 500 shows different WUS periodicities in accordance with the present disclosure. In part (A) of FIG. 5, the WUS periodicity is equivalent to one DRX cycle or gap (e.g., 40 ms). In part (B) of FIG. 5, the WUS periodicity is equivalent to an eDRX short cycle of gap (e.g., 160 ms). In part (C) of FIG. 5, the WUS periodicity is equivalent to an eDRX long cycle of gap (e.g., 1 s). In each of parts (A), (B) and (C), various types of WUS maybe transmitted by a base station such as, for example and without limitation, a WUS in accordance with release 15 (Rel-15) of the 3GPP specification for NB-IoT, a common WUS, a UE-group WUS for a first group of UEs (denoted as “UE-group WUS #1” in FIG. 5), and a UE-group WUS for a second group of UEs (denoted as “UE-group WUS #2” in FIG. 5). The common WUS, the UE-group WUS for the first group of UEs, and the UE-group WUS for the second group of UEs may be in accordance with release 16 (Rel-16) of the 3GPP specification for NB-IoT and, hence, are together denoted as “Rel-16 WUS” in FIG. 5. The Rel-16 WUS may be transmitted via a single sequence CDM.

### Illustrative Implementations

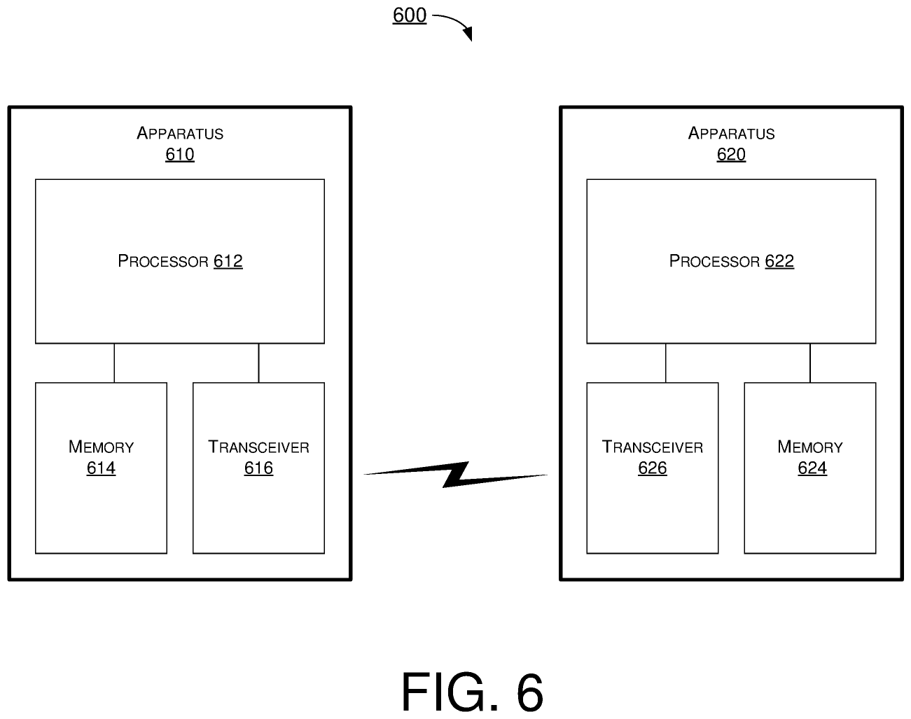

FIG. 6 illustrates an example communication environment 600 having an example apparatus 610 and an example apparatus 620 in accordance with an implementation of the present disclosure. Each of apparatus 610 and apparatus 620 may perform various functions to implement schemes, techniques, processes and methods described herein pertaining to UE-group WUS in NB-IoT, including various schemes described above as well as processes 700 and 800 described below.

Each of apparatus 610 and apparatus 620 may be a part of an electronic apparatus, which may be a UE such as a portable or mobile apparatus, a wearable apparatus, a wireless communication apparatus or a computing apparatus. For instance, each of apparatus 610 and apparatus 620 may be implemented in a smartphone, a smartwatch, a personal digital assistant, a digital camera, or a computing equipment such as a tablet computer, a laptop computer or a notebook computer. Each of apparatus 610 and apparatus 620 may also be a part of a machine type apparatus, which may be an IoT or NB-IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. Alternatively, each of apparatus 610 and apparatus 620 may be implemented in the form of one or more integrated-circuit (IC) chips such as, for example and without limitation, one or more single-core processors, one or more multi-core processors, or one or more complex-instruction-set-computing (CISC) processors. Each of apparatus 610 and apparatus 620 may include at least some of those components shown in FIG. 6 such as a processor 612 and a processor 622, respectively. Each of apparatus 610 and apparatus 620 may further include one or more other components not pertinent to the proposed scheme of the present disclosure (e.g., internal power supply, display device and/or user interface device), and, thus, such component(s) of each of apparatus 610 and apparatus 620 are neither shown in FIG. 6 nor described below in the interest of simplicity and brevity.

In some implementations, at least one of apparatus 610 and apparatus 620 may be a part of an electronic apparatus, which may be a network node or base station (e.g., eNB, gNB or transmit/receive point (TRP)), a small cell, a router or a gateway. For instance, at least one of apparatus 610 and apparatus 620 may be implemented in an eNodeB in an LTE, LTE-Advanced or LTE-Advanced Pro network or in a gNB in a 5G, NR, IoT or NB-IoT network. Alternatively, at least one of apparatus 610 and apparatus 620 may be implemented in the form of one or more IC chips such as, for example and without limitation, one or more single-core processors, one or more multi-core processors, or one or more CISC processors.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including UE-group WUS in NB-IoT in accordance with various implementations of the present disclosure.

In some implementations, apparatus 610 may also include a transceiver 616 coupled to processor 612 and capable of wirelessly transmitting and receiving data. In some implementations, apparatus 610 may further include a memory 614 coupled to processor 612 and capable of being accessed by processor 612 and storing data therein. In some implementations, apparatus 620 may also include a transceiver 626 coupled to processor 622 and capable of wirelessly transmitting and receiving data. In some implementations, apparatus 620 may further include a memory 624 coupled to processor 622 and capable of being accessed by processor 622 and storing data therein. Accordingly, apparatus 610 and apparatus 620 may wirelessly communicate with each other via transceiver 616 and transceiver 626, respectively.

To aid better understanding, the following description of the operations, functionalities and capabilities of each of apparatus 610 and apparatus 620 is provided in the context of a NB-IoT communication environment in which apparatus 610 is implemented in or as a wireless communication device, a communication apparatus or a UE and apparatus 620 is implemented in or as a network node (e.g., base station 108) connected or otherwise communicatively coupled to a wireless network (e.g., wireless network 105).

In one aspect of UE-group WUS in NB-IoT in accordance with the present disclosure, processor 622 of apparatus 620 as a network node may indicate, via transceiver 626, to a plurality of UEs (e.g., UE 110˜UE 180) a paging configuration of a UE-group wake-up signal (WUS) for one or more groups of UEs among the plurality of UEs in an NB-IoT cell. The paging configuration may be related to a discontinuous reception (DRX) cycle and a value related to UE identification (UE_ID) of each UE in the one or more groups of UEs. Moreover, processor 622 may transmit, via transceiver 626, the UE-group WUS to the one or more groups of UEs.

In some implementations, in transmitting the UE-group WUS to the one or more groups of UEs, processor 622 may transmit the UE-group WUS with a same DRX configuration in a same time or frequency resource.

In some implementations, in transmitting the UE-group WUS in the same time or frequency resource, processor 622 may transmit the UE-group WUS in the same time or frequency resource via time-division multiplexing (TDM), code-division multiplexing (CDM), or both TDM and CDM.

In some implementations, in transmitting the UE-group WUS to the one or more groups of UEs, processor 622 may transmit the UE-group WUS within a PO.

In some implementations, a periodicity of the WUS may be a multiple of the DRX cycle. That is, one cycle of the WUS may be equivalent to multiple DRX cycles.

In some implementations, the UE-group WUS may be applicable to an extended discontinuous reception (eDRX) cycle such that UEs in the one or more groups of UEs monitor for one or more POs within a paging transmission window (PTW).

In some implementations, processor 622 may postpone paging in a PO responsive to there being no associated WUS configured for the PO.

In some implementations, processor 622 may drop paging in a PO responsive to there being no associated WUS configured for the PO.

In some implementations, processor 622 may indicate, via transceiver 626, to at least one UE of the plurality of UEs support for the UE-group WUS. In such cases, in indicating the support for the UE-group WUS, processor 622 may indicate the support for the UE-group WUS via a radio resource control (RRC) configuration.

In one aspect of UE-group WUS in NB-IoT in accordance with the present disclosure, processor 612 of apparatus 610 as a UE may receive, via transceiver 616, from a wireless network (e.g., from wireless network 105 via apparatus 620 as base station 108) a paging configuration of a UE-group WUS for one or more groups of UEs, to which the UE belongs, among the plurality of UEs (e.g., UE 110˜180) in an NB-IoT cell. The paging configuration may be related to a DRX cycle and a value related to UE identification (UE_ID) of each UE in the one or more groups of UEs. Moreover, processor 612 may receive, via transceiver 616, from the wireless network the UE-group WUS.

In some implementations, in receiving the UE-group WUS, processor 612 may receive the UE-group WUS with a same DRX configuration in a same time or frequency resource.

In some implementations, in receiving the UE-group WUS in the same time or frequency resource, processor 612 may receive the UE-group WUS in the same time or frequency resource via TDM, CDM, or both TDM and CDM.

In some implementations, in receiving the UE-group WUS, processor 612 may receive the UE-group WUS within a PO.

In some implementations, a periodicity of the WUS may be a multiple of the DRX cycle. That is, one cycle of the WUS may be equivalent to multiple DRX cycles.

In some implementations, processor 612 may monitor for one or more POs within a PTW. In such cases, the UE-group WUS may be applicable to an eDRX cycle.

In some implementations, processor 612 may receive, via transceiver 616, postponed paging in a PO responsive to there being no associated WUS configured for the PO.

In some implementations, processor 612 may not receive any paging in a PO responsive to there being no associated WUS configured for the PO.

In some implementations, processor 612 may receive, via transceiver 616, from the wireless network an indication of support for the UE-group WUS. In such cases, in receiving the indication of the support for the UE-group WUS, processor 612 may receive the indication of the support for the UE-group WUS via an RRC configuration.

### Illustrative Processes

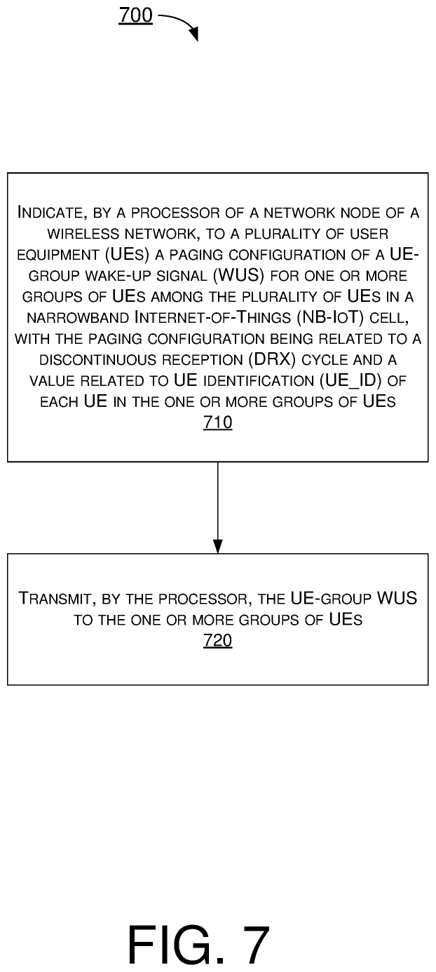

FIG. 7 illustrates an example process 700 in accordance with an implementation of the present disclosure. Process 700 may be an example implementation of the proposed schemes described above with respect to UE-group WUS in NB-IoT in accordance with the present disclosure. Process 700 may represent an aspect of implementation of features of apparatus 610 and apparatus 620. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 610, apparatus 620 and/or any suitable wireless communication device, UE, base station or machine type devices. Solely for illustrative purposes and without limitation, process 700 is described below in the context of apparatus 610 as a UE (e.g., UE 110) and apparatus 620 as a network node (e.g., base station 108) of a wireless network (e.g., wireless network 105). Process 700 may begin at block 710.

At 710, process 700 may involve processor 622 of apparatus 620 as a network node indicating, via transceiver 626, to a plurality of UEs (e.g., UE 110˜UE 180) a paging configuration of a UE-group wake-up signal (WUS) for one or more groups of UEs among the plurality of UEs in an NB-IoT cell. The paging configuration may be related to a discontinuous reception (DRX) cycle and a value related to UE identification (UE_ID) of each UE in the one or more groups of UEs. Process 700 may proceed from 710 to 720.

At 720, process 700 may involve processor 622 transmitting, via transceiver 626, the UE-group WUS to the one or more groups of UEs.

In some implementations, in transmitting the UE-group WUS to the one or more groups of UEs, process 700 may involve processor 622 transmitting the UE-group WUS with a same DRX configuration in a same time or frequency resource.

In some implementations, in transmitting the UE-group WUS in the same time or frequency resource, process 700 may involve processor 622 transmitting the UE-group WUS in the same time or frequency resource via time-division multiplexing (TDM), code-division multiplexing (CDM), or both TDM and CDM.

In some implementations, in transmitting the UE-group WUS to the one or more groups of UEs, process 700 may involve processor 622 transmitting the UE-group WUS within a PO.

In some implementations, a periodicity of the WUS may be a multiple of the DRX cycle. That is, one cycle of the WUS may be equivalent to multiple DRX cycles.

In some implementations, the UE-group WUS may be applicable to an extended discontinuous reception (eDRX) cycle such that UEs in the one or more groups of UEs monitor for one or more POs within a paging transmission window (PTW).

In some implementations, process 700 may also involve processor 622 postponing paging in a PO responsive to there being no associated WUS configured for the PO.

In some implementations, process 700 may also involve processor 622 dropping paging in a PO responsive to there being no associated WUS configured for the PO.

In some implementations, process 700 may also involve processor 622 indicating, via transceiver 626, to at least one UE of the plurality of UEs support for the UE-group WUS. In such cases, in indicating the support for the UE-group WUS, process 700 may also involve processor 622 indicating the support for the UE-group WUS via a radio resource control (RRC) configuration.

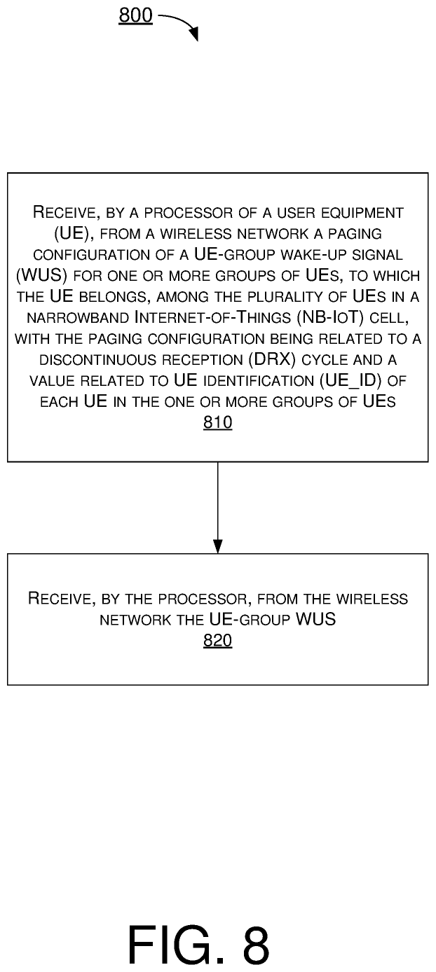

FIG. 8 illustrates an example process 800 in accordance with an implementation of the present disclosure. Process 800 may be an example implementation of the proposed schemes described above with respect to UE-group WUS in NB-IoT in accordance with the present disclosure. Process 800 may represent an aspect of implementation of features of apparatus 610 and apparatus 620. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may also be repeated partially or entirely. Process 800 may be implemented by apparatus 610, apparatus 620 and/or any suitable wireless communication device, UE, base station or machine type devices. Solely for illustrative purposes and without limitation, process 800 is described below in the context of apparatus 610 as a UE (e.g., UE 110) and apparatus 620 as a network node (e.g., base station 108) of a wireless network (e.g., wireless network 105). Process 800 may begin at block 810.

At 810, process 800 may involve processor 612 of apparatus 610 as a UE receiving, via transceiver 616, from a wireless network (e.g., from wireless network 105 via apparatus 620 as base station 108) a paging configuration of a UE-group WUS for one or more groups of UEs, to which the UE belongs, among the plurality of UEs (e.g., UE 110˜180) in an NB-IoT cell. The paging configuration may be related to a DRX cycle and a value related to UE identification (UE_ID) of each UE in the one or more groups of UEs. Process 800 may proceed from 810 to 820.

At 820, process 800 may involve processor 612 receiving, via transceiver 616, from the wireless network the UE-group WUS.

In some implementations, in receiving the UE-group WUS, process 800 may involve processor 612 receiving the UE-group WUS with a same DRX configuration in a same time or frequency resource.

In some implementations, in receiving the UE-group WUS in the same time or frequency resource, process 800 may involve processor 612 receiving the UE-group WUS in the same time or frequency resource via TDM, CDM, or both TDM and CDM.

In some implementations, in receiving the UE-group WUS, process 800 may involve processor 612 receiving the UE-group WUS within a PO.

In some implementations, a periodicity of the WUS may be a multiple of the DRX cycle. That is, one cycle of the WUS may be equivalent to multiple DRX cycles.

In some implementations, process 800 may also involve processor 612 monitoring for one or more POs within a PTW. In such cases, the UE-group WUS may be applicable to an eDRX cycle.

In some implementations, process 800 may also involve processor 612 receiving, via transceiver 616, postponed paging in a PO responsive to there being no associated WUS configured for the PO.

In some implementations, process 800 may also involve processor 612 not receiving paging in a PO responsive to there being no associated WUS configured for the PO.

In some implementations, process 800 may also involve processor 612 receiving, via transceiver 616, from the wireless network an indication of support for the UE-group WUS. In such cases, in receiving the indication of the support for the UE-group WUS, process 800 may involve processor 612 receiving the indication of the support for the UE-group WUS via an RRC configuration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
indicating, by a processor of a network node of a wireless network, to a plurality of user equipment (UEs) a paging configuration of a UE-group wake-up signal (WUS) for one or more groups of UEs among the plurality of UEs in a narrowband Internet-of-Things (NB-IoT) cell; and
transmitting, by the processor, the UE-group WUS to the one or more groups of UEs.
wherein the paging configuration is related to a discontinuous reception (DRX) cycle and a value related to UE identification (UE_ID) of each UE in the one or more groups of UEs.

2. The method of claim 1, wherein the transmitting of the UE-group WUS to the one or more groups of UEs comprises transmitting the UE-group WUS with a same DRX configuration in a same time or frequency resource.

3. The method of claim 2, wherein the transmitting of the UE-group WUS in the same time or frequency resource comprises transmitting the UE-group WUS in the same time or frequency resource via time-division multiplexing (TDM), code-division multiplexing (CDM), or both TDM and CDM.

4. The method of claim 1, wherein the transmitting of the UE-group WUS to the one or more groups of UEs comprises transmitting the UE-group WUS within a paging occasion (PO).

5. The method of claim 1, wherein a periodicity of the WUS is a multiple of the DRX cycle.

6. The method of claim 1, wherein the UE-group WUS is applicable to an extended discontinuous reception (eDRX) cycle such that UEs in the one or more groups of UEs monitor for one or more paging occasions (POs) within a paging transmission window (PTW).

7. The method of claim 1, further comprising:
postponing, by the processor, paging in a paging occasion (PO) responsive to there being no associated WUS configured for the PO.

8. The method of claim 1, further comprising:
dropping, by the processor, paging in a paging occasion (PO) responsive to there being no associated WUS configured for the PO.

9. The method of claim 1, further comprising:
indicating, by the processor, to at least one UE of the plurality of UEs support for the UE-group WUS.

10. The method of claim 9, wherein the indicating of the support for the UE-group WUS comprising indicating the support for the UE-group WUS via a radio resource control (RRC) configuration.

11. A method, comprising:
receiving, by a processor of a user equipment (UE), from a wireless network a paging configuration of a UE-group wake-up signal (WUS) for one or more groups of UEs, to which the UE belongs, among the plurality of UEs in a narrowband Internet-of-Things (NB-IoT) cell; and
receiving, by the processor, from the wireless network the UE-group WUS.
wherein the paging configuration is related to a discontinuous reception (DRX) cycle and a value related to UE identification (UE_ID) of each UE in the one or more groups of UEs.

12. The method of claim 11, wherein the receiving of the UE-group WUS comprises receiving the UE-group WUS with a same DRX configuration in a same time or frequency resource.

13. The method of claim 12, wherein the receiving of the UE-group WUS in the same time or frequency resource comprises receiving the UE-group WUS in the same time or frequency resource via time-division multiplexing (TDM), code-division multiplexing (CDM), or both TDM and CDM.

14. The method of claim 11, wherein the receiving of the UE-group WUS comprises receiving the UE-group WUS within a paging occasion (PO).

15. The method of claim 11, wherein a periodicity of the WUS is a multiple of the DRX cycle.

16. The method of claim 11, further comprising:
monitoring, by the processor, for one or more paging occasions (POs) within a paging transmission window (PTW),
wherein the UE-group WUS is applicable to an extended discontinuous reception (eDRX) cycle.

17. The method of claim 11, further comprising:
receiving, by the processor, postponed paging in a paging occasion (PO) responsive to there being no associated WUS configured for the PO.

18. The method of claim 11, further comprising:
not receiving, by the processor, paging in a paging occasion (PO) responsive to there being no associated WUS configured for the PO.

19. The method of claim 11, further comprising:
receiving, by the processor, from the wireless network an indication of support for the UE-group WUS.

20. The method of claim 19, wherein the receiving of the indication of the support for the UE-group WUS comprising receiving the indication of the support for the UE-group WUS via a radio resource control (RRC) configuration.
